(19) United States
(12) Patent Application Publication
(10) Pub. No.: US 2013/0050594 A1
(43) Pub. Date: Feb. 28, 2013

(54) THREE-DIMENSIONAL IMAGE DISPLAY APPARATUS

(71) Applicants: Yuzo HIRAYAMA, Yokohama-shi (JP); Rieko FUKUSHIMA, Tokyo (JP); Tatsuo SAISHU, Kokubunji-shi (JP)

(72) Inventors: Yuzo HIRAYAMA, Yokohama-shi (JP); Rieko FUKUSHIMA, Tokyo (JP); Tatsuo SAISHU, Kokubunji-shi (JP)

(21) Appl. No.: 13/359,801

(22) Filed: Jan. 27, 2012

(30) Foreign Application Priority Data
Aug. 26, 2011 (JP) 2011-185210

(51) Int. Cl. G02F 1/1335

(52) U.S. Cl. 349/15

(57) ABSTRACT

According to one embodiment, a three-dimensional image display apparatus includes a display unit and liquid crystal lenses. A plurality of sub-pixels may be arrayed in a matrix in a first direction and a second direction in the display unit. The liquid crystal lenses may be arrayed in the first direction at not more than a horizontal pitch p, which is expressed by:

$$p = 3 \times \sqrt{\frac{N \times 3 - 1}{3}} ( unit \text{:} a sub \text{-} pixel width )$$

where N is the number of parallaxes.

### CROSS-REFERENCE TO RELATED APPLICATIONS

This application is based upon and claims the benefit of priority from prior Japanese Patent Application No. 2011-185210, filed Aug. 26, 2011, the entire contents of which are incorporated herein by reference.

### FIELD

Embodiments described herein relate generally to a three-dimensional image display apparatus.

### BACKGROUND

As a three-dimensional (3D) image display apparatus which can display a moving image, that is, a so-called 3D display, various systems are known. In recent years, especially, a system which adopts a flat-panel type, and does not require any dedicated glasses is strongly demanded. As one 3D image display apparatus of a type which does not require any dedicated glasses, a system in which a ray control element is arranged immediately in front of a display panel, and rays coming from the display panel are controlled to be directed toward a viewer is known. As the display panel (display device), a direct-viewing or projection type liquid crystal display device or plasma display device is used, and pixel positions of that display are fixed.

The ray control element has a function that allows the viewer to view different images depending on angles when the viewer views an identical point on the ray control element. When the ray control element gives only a right-and-left parallax (horizontal parallax), a slit (parallax barrier) or lenticular sheet (cylindrical lens array) is used as the ray control element. When the ray control element gives an up-and-down parallax (vertical parallax) in addition to the right-and-left parallax, a pinhole array or lens array is used as the ray control element.

The system using the ray control element is classified into a two-view system, multi-view system, super-multi-view system (which satisfies super-multi-view conditions in the multi-view system), and integral imaging (to be also referred to as “II” hereinafter) system. The two-view system attains stereoscopic viewing based on a binocular parallax. Since images generated by the systems after the multi-view system include motion parallaxes on one level or another, they are called “3D images” to be distinguished from stereoscopic images of the two-view system. The basic principle required to display these 3D images is substantially the same as that of integral photography (IP) which was invented about 100 years ago and is applied to 3D photographs.

Of these 3D image display systems, the II system features high degrees of freedom in viewpoint position, thus a viewer can easily enjoy stereoscopic viewing. In a one-dimensional (1D) II system which provides only the horizontal parallax but does not provide any vertical parallax, a high-resolution display device can be relatively easily implemented.

Furthermore, in recent years, in order to provide novel functions to a 3D image display apparatus, many studies concerning applications of liquid crystal lenses as a ray control element have been carried out. For example, a 3D image display apparatus, which can selectively display 2D and 3D images, has a higher display quality than the conventional system, allows high-speed switching, and can display 2D and 3D images together on arbitrarily selected regions, has been implemented.

### BRIEF DESCRIPTION OF THE DRAWINGS

FIG. 1 is a schematic enlarged view of a display unit of a 3D image display apparatus according to an embodiment;

FIG. 2A is a view showing a liquid crystal lens or liquid crystal polymer lens;

FIG. 2B is a sectional view showing a liquid crystal GRIN lens;

FIG. 3A is a sectional view showing the liquid crystal GRIN lens;

FIG. 3B is a sectional view showing the liquid crystal GRIN lens;

FIG. 4A is a view showing an example of a 2D/3D switching display;

FIG. 4B is a view showing another example of the 2D/3D switching display;

FIG. 4C is a view showing still another example of the 2D/3D switching display;

FIG. 4D is a view showing yet another example of the 2D/3D switching display;

FIG. 5A is a view showing 3D pixels configured by triplets each including R, G, and B sub-pixels;

FIG. 5B is a view showing 3D pixels configured by triplets each including R, G, and B sub-pixels;

FIG. 6 is a view showing the relationship between pixels and liquid crystal lenses when a horizontal pitch of lenses is set to be 1.5 sub-pixels;

FIG. 7 is a view showing an example in which vertical lenses are laid out on a liquid crystal panel;

FIG. 8 is a view showing an example in which slant lenses are laid out on a liquid crystal panel;

FIG. 9 is an explanatory view of a case in which a tilt angle θ of the slant lenses is a tan(1/n) and n=6, and a horizontal pitch p of lenses is 3× the number of parallaxes/n (unit: a sub-pixel width); and

FIG. 10 shows another embodiment.

### DETAILED DESCRIPTION

In general, according to one embodiment, a three-dimensional image display apparatus includes a display unit and liquid crystal lenses. A plurality of sub-pixels may be arrayed in a matrix in a first direction and a second direction in the display unit.

The liquid crystal lenses may be arrayed in the first direction at not more than a horizontal pitch p, which is expressed by:

$$p = 3 \times \sqrt{\frac{N \times 3 - 1}{3}} ( unit \text{:} a sub \text{-} pixel width )$$

where N is the number of parallaxes.

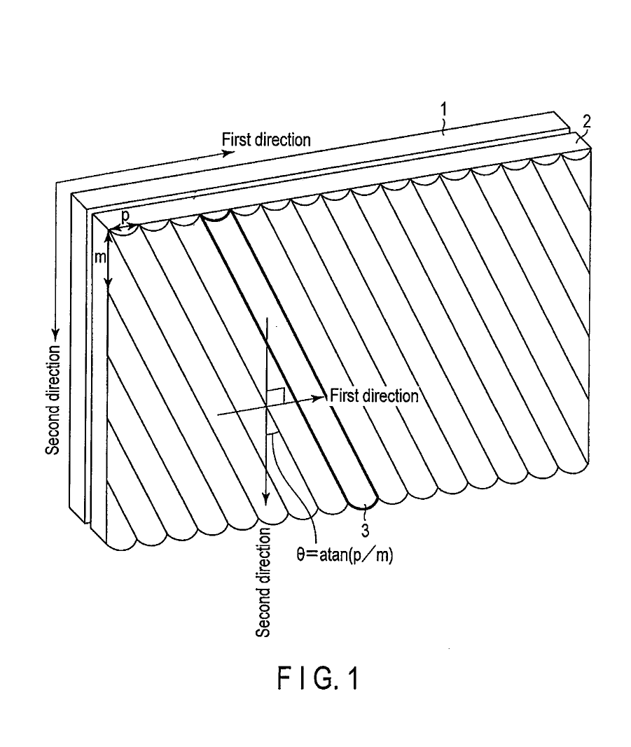

FIG. 1 is a schematic enlarged view of a display unit of a 3D image display apparatus according to an embodiment. This apparatus has an LCD (Liquid Crystal Display) 1, a lens base portion 2, and light refracting portions 3. The LCD 1 is a display unit having a plurality of sub-pixels, which are arrayed in a matrix in a horizontal direction (first direction) and vertical direction (second direction). A shape of one sub-pixel is basically a rectangle or parallelogram in which a ratio of lengths of the short side and long side is 1:3, the outer shape and interior of which are modified as needed. Three sub-pixels arrayed in the first direction form one pixel. The three sub-pixels are provided with color filters to display one of R (red), G (green), and B (blue). Light coming from a backlight (not shown) is converted into rays, whose color is specified as one of R, G, and B by the color filter, and these rays pass through the lens base portion 2 and light refracting portions 3 (ray control elements) to be projected as rays to the front side of the display unit, thus displaying a 3D image.

As shown in FIG. 1, the light refracting portion 3 has a nearly cylindrical shape extending in the second direction, and a plurality of such light refracting portions 3 are arrayed along the first direction. As can be seen from FIG. 1, the light refracting portions 3 may be obliquely laid out along the first direction. Letting p be a length of the light refracting portion 3 in the first direction and m be a length in the second direction, this tilt is given by θ=a tan(p/m).

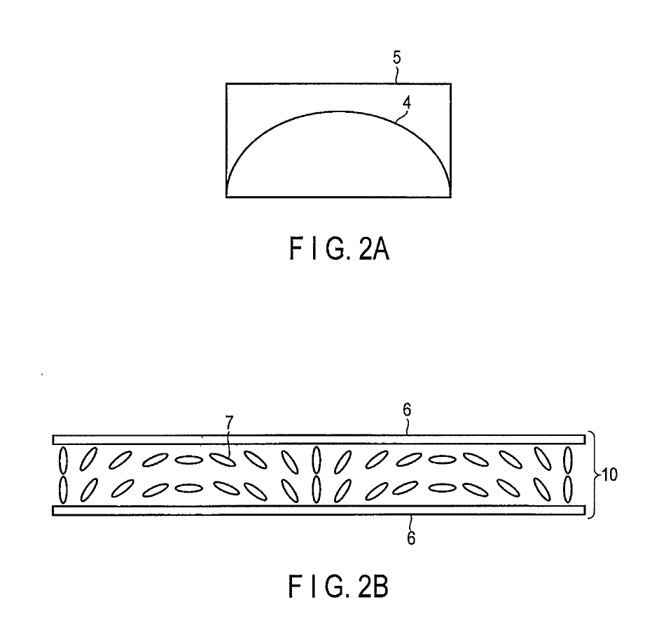

The light refracting portions 3 serve as ray control elements, and can use liquid crystal lenses or liquid crystal polymer lenses. The liquid crystal lens and liquid crystal polymer lens will be described below with reference to FIG. 2A. The liquid crystal lens is a lens which uses a liquid crystal. For example, as shown in FIG. 2A, the liquid crystal lens can be prepared by sealing a liquid crystal 4 in a lens-shaped form 5. As a material of the form 5, a UV (ultraviolet) curable resin or the like is used. Such liquid crystal lens can be used as a lens having polarization dependency. The liquid crystal polymer lens is a lens using liquid crystal polymers, and has a structure in which the liquid crystal 4 is sealed in the lens-shaped form 5 as in the liquid crystal lens. The liquid crystal polymer may often have a solid state.

In this embodiment, as the light refracting portions 3, a liquid crystal GRIN (Graded Index or Gradient Index) lens 10 shown in FIG. 2B is used. The liquid crystal GRIN lens 10 is one type of liquid crystal lenses in which liquid crystal molecules 7 are sealed between two transparent substrates 6, as is well-known. The liquid crystal molecule 7 has an elongated structure, and a longitudinal direction of a liquid crystal molecule is called a director. The liquid crystal molecule 7 has a birefringence, and develops different refractive indices (Ne, No) depending on whether a direction of polarization is parallel or perpendicular to the director.

That is, when the liquid crystal molecules are aligned in a given direction between the two transparent substrates 6, since the directors are directed in the same direction to set a constant refractive index in a lens pitch, the liquid crystal GRIN lens 10 does not have any lens effect. On the other hand, using the feature of the liquid crystal molecules 7 as a dielectric, a voltage is applied to the liquid crystal molecules 7 to change tilts of the directors in the lens pitch. FIG. 2B does not illustrate any electrode used to apply a voltage. In a given direction of polarization, the tilts of the directors of the liquid crystal molecules form a refractive index distribution, and the liquid crystal GRIN lens 10 can be provided with a lens effect. Note that a focal length of a lens can be changed by different voltage application methods.

(2D/3D Switching)

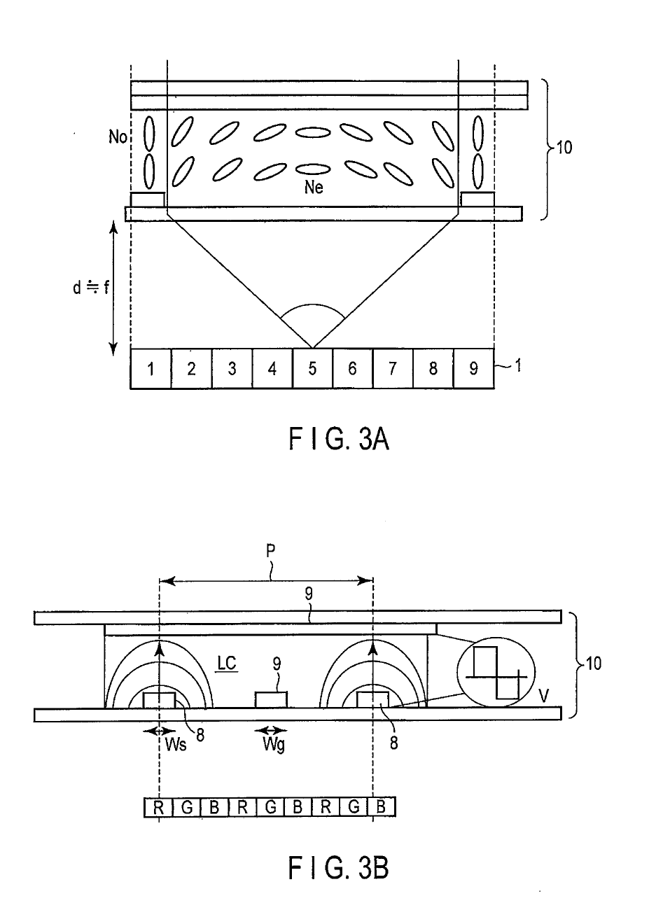

In general, in a naked-eye type 3D display, a display resolution is lower than an original panel, but it is required to allow a viewer to view a conventional 2D content at an original high resolution. As described above with reference to FIG. 2B, the liquid crystal GRIN lens 10 develops different refractive indices (Ne, No) depending on whether the direction of polarization is parallel or perpendicular to the directors. When the liquid crystal molecules are aligned in a given direction between the two transparent substrates, since the directors are directed in the same direction, a constant refractive index is set in the lens pitch, thus allowing a display to be 2D mode. On the other hand, when the tilts of the directors are changed in the lens pitch by applying a voltage, the tilts of the directors of the liquid crystal molecules form a refractive index distribution in a given direction of polarization, and a lens effect can be provided. When a focal length f of the liquid crystal GRIN lens 10 is roughly matched with a distance d between the lens 10 and display pixels (LCD 1), light coming from a pixel (for example, a pixel No. 5) for one parallax in the lens pitch p is enlarged up to the lens pitch p and is output, as shown in FIG. 3A. Thus, since rays from different pixels can be viewed according to a desired direction, the naked-eye 3D display can be implemented. FIG. 3B is a sectional view of the liquid crystal GRIN lens 10. This example shows a 3-line structure in which each ground line 9 is set between two power supply lines 8, but the electrode structure can be changed as needed.

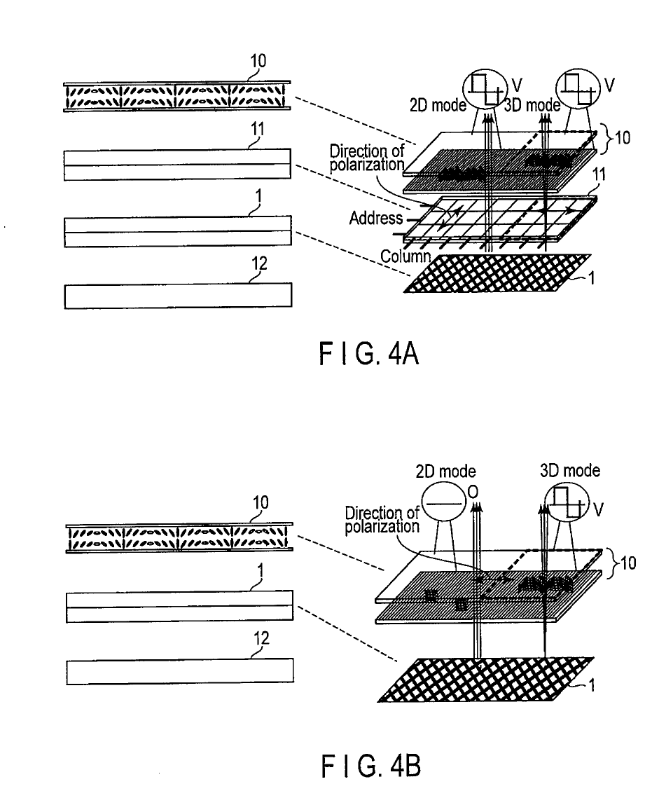

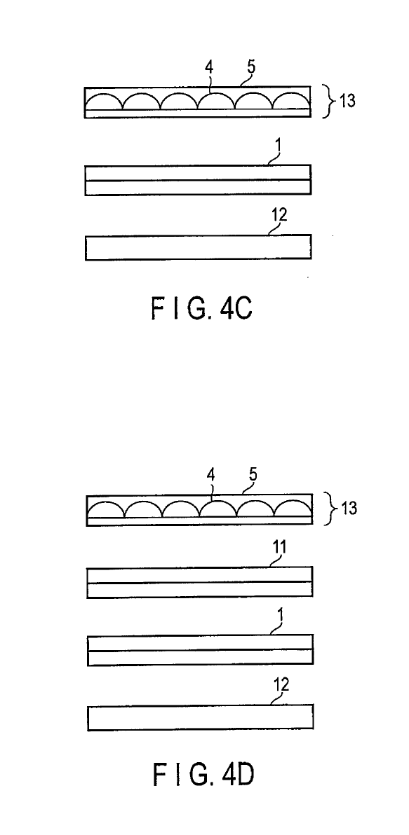

FIG. 4A shows an embodiment of a 3D image display apparatus including a 2D/3D switching mechanism. The apparatus shown in FIG. 4A uses a TN (Twisted Nematic) liquid crystal cell 11 as a liquid crystal switching cell used to switch a direction of polarization, and uses the liquid crystal GRIN lens 10 as a 3D display optical element. The LCD 1 is irradiated with light coming from a backlight 12. Light coming from the LCD 1 enters the liquid crystal GRIN lens 10 via the TN liquid crystal cell 11. In the arrangement shown in FIG. 4A, a voltage V is always applied to the liquid crystal GRIN lens 10 in both 2D and 3D modes. In the 3D mode, a voltage is applied to the TN liquid crystal cell 11, so that the direction of polarization is parallel to liquid crystal directors. On the other hand, in the 2D mode, no voltage is applied to the TN liquid crystal cell 11. In this case, the direction of polarization is rotated through 90° due to a TN mode. In this manner, the lens effect of the liquid crystal GRIN lens 10 can be enabled/disabled by the TN liquid crystal cell 11.

Another arrangement which enables/disables the lens effect by turning on/off the voltage V to be applied to the liquid crystal GRIN lens 10 between the 2D mode and 3D mode may be adopted, as shown in FIG. 4B.

As described above, in the embodiment using the liquid crystal GRIN lens 10 as a ray control element, when the tilts of the directors form a refractive index distribution upon application of a voltage, the liquid crystal GRIN lens 10 can be provided with a lens effect, thus allowing a viewer to view a 3D image. On the other hand, when no voltage is applied, the liquid crystal GRIN lens 10 does not have any lens effect, and the LCD 1 (that is, a base 2D panel) is directly viewed, thus allowing a high-definition 2D display.

Note that a liquid crystal lens 13 shown in FIG. 2A may be used in place of the liquid crystal GRIN lens 10, as shown in FIG. 4C or 4D.

When a 3D image display apparatus which allows a 3D display without requiring any dedicated glasses adopts a large panel size, a large liquid crystal lens also has to be applied. In this case, an increase in lens thickness disturbs alignment of liquid crystal molecules in the lens to deteriorate lens characteristics, resulting in a 3D image quality drop. In general, in order to stabilize directions of directors of liquid crystal molecules, alignment films such as polyimide films are formed on surfaces of glass or resin substrates or forms in which a liquid crystal is sealed, and undergo a rubbing treatment by, for example, rubbing a cloth in one direction. Since the alignment films have an alignment, the liquid crystal molecules are influenced by that alignment, and the directions of the directors are aligned. However, when a liquid crystal thickness is increased, an alignment restraining force of the alignment films cannot be reached, thus distributing the directions of the directors. The liquid crystal lens can no longer have an effect as a lens. When the liquid crystal thickness exceeds 100 [μm], alignments are normally disturbed, although this depends on the types of liquid crystal materials. Hence, in this embodiment, an upper limit and/or a lower limit is specified for a lens pitch, and about half a lens pitch of the conventional pitch is set to nearly halve the liquid crystal thickness, thus implementing a stable liquid crystal lens, as will be described below.

(Upper Limit of Horizontal Pitch of Liquid Crystal Lens)

In the case of a conventional parallel-ray II system, an integer multiple of the number of parallaxes is often used as a horizontal pitch of liquid crystal lenses. For example, in the case of nine parallaxes, the horizontal pitch of the liquid crystal lenses is set to be 9 [sub-pixel widths]. Letting N be the number of parallaxes, L be a viewing distance, and g be a gap between the lens and pixel, a horizontal pitch p of the liquid crystal lenses in the case of the multi-view system is specified by:

$$p = 3 \times \sqrt{N} \times \frac{L}{L + G} ( unit \text{:} a sub \text{-} pixel width )$$

For example, when L=2.5 [m] and g=3 [mm], p=8.999 [sub-pixel widths]. However, in such a conventional design, the liquid crystal lenses have a larger size as a screen size increases, and the thickness of a liquid crystal layer often exceeds a stable region.

Hence, in this embodiment, an upper limit of the horizontal pitch of the liquid crystal lenses is specified to be equal to or smaller than p, which is given by:

$$p = 3 \times \sqrt{\frac{N \times 3 - 1}{3}} ( unit \text{:} a sub \text{-} pixel width )$$

For example, in the case of nine parallaxes, an upper limit of the horizontal pitch of the liquid crystal lenses is set to be equal to or smaller than p=8.83 [sub-pixel widths]. Then, the thickness of the liquid crystal layer is effectively reduced to obtain satisfactory liquid crystal lens characteristics.

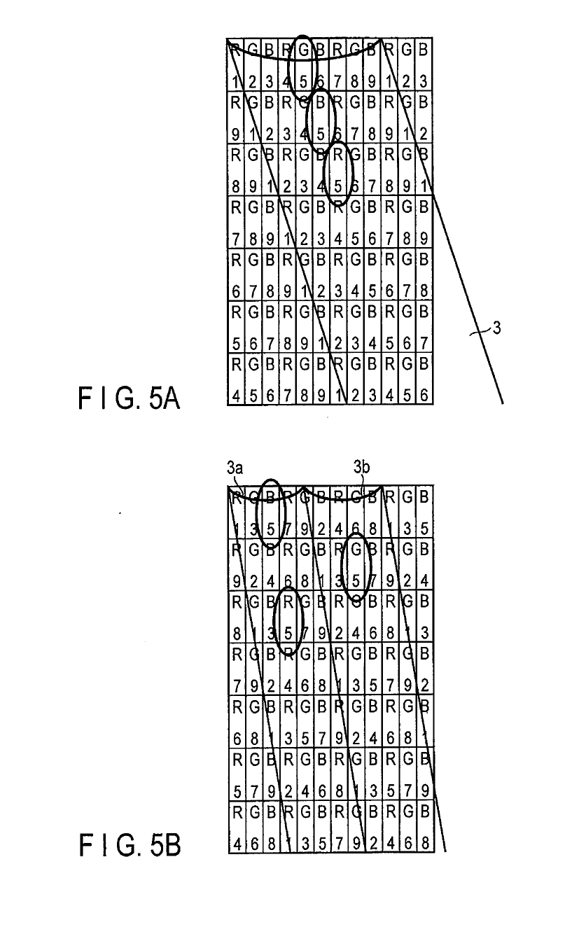

With the conventional lens pitch, one liquid crystal lens 3 includes 3D pixels configured by triplets each including R, G, and B sub-pixels, as shown in FIG. 5A. As shown in FIG. 5A, one triplet is configured by three sub-pixels with circular marks. These three sub-pixels fall within one liquid crystal lens 3 which is tilted in the horizontal direction.

In this case, FIG. 5B shows a case which satisfies the condition given by equation (2) above. As can be seen from FIG. 5B, a 3D pixel configured by a triplet including R, G, and B sub-pixels exists across two or more liquid crystal lenses 3a and 3b. That is, two sub-pixels which configure one triplet exist on the liquid crystal lens 3a, and one remaining sub-pixel exists on the liquid crystal lens 3b. This means that a plurality of 3D pixels are laid out on the entire screen in a overlapping pattern, and an effect of improving a resolution is also expected. Furthermore, a 3D pixel configured by a triplet including R, G, and B sub-pixels may exist across three liquid crystal lenses.

(Liquid Crystal Lens Pitch)

A liquid crystal lens pitch will be described below. In the case of a structure obtained by sealing a liquid crystal or liquid crystal polymer in a large number of lens-shaped forms, these lens-shaped forms have a given period. This period is called a “lens pitch” of liquid crystal lenses or liquid crystal polymer lenses. Note that the lens pitch is a pitch in a direction perpendicular to a lens ridge. However, when lenses are laid out to have a tilt, a pitch in the horizontal direction (p in FIG. 1) is especially called a “horizontal lens pitch”.

On the other hand, since the liquid crystal GRIN lens or the like does not have any lens form, the aforementioned definition cannot be applied. However, the directions of liquid crystal directors change periodically. Therefore, the period of the liquid crystal directors can be defined as a lens pitch of the liquid crystal lenses. This lens pitch has a strong correlation with a pitch of electrodes, which are laid out periodically. Note that in this case as well, when the lens is laid out to have a tilt, a pitch in the horizontal direction is especially called a “horizontal lens pitch”.

(Specifying Lower Limit of Horizontal Pitch of Lens)

As the horizontal lens pitch is smaller, the size of the liquid crystal lens can be decreased. Therefore, the thickness of the liquid crystal lens can also be reduced. However, since side effects occur when the horizontal lens pitch is too small, the horizontal lens pitch has a lower limit.

For example, as the horizontal lens pitch becomes smaller, a spread of rays emanating from a liquid crystal lens becomes smaller, resulting in a narrower visible range. In order to compensate for this effect, an appropriate design (for example, the thickness of each layer of a 3D panel is adjusted to reduce a distance between pixels and liquid crystal lenses) is required. On the other hand, a true lower limit is a minimum lens pitch that allows stereoscopic viewing to function. In order to allow stereoscopic viewing, at least two rays have to be output from one liquid crystal lens. This is because when only one ray is output from one lens, the same pixel is seen, regardless of direction, resulting in a 2D display. When a horizontal lens pitch is larger than one sub-pixel width even slightly, two rays are output from one liquid crystal lens. Therefore, as can be understood from the above description, the lower limit of the horizontal pitch of lenses is larger than one sub-pixel width.

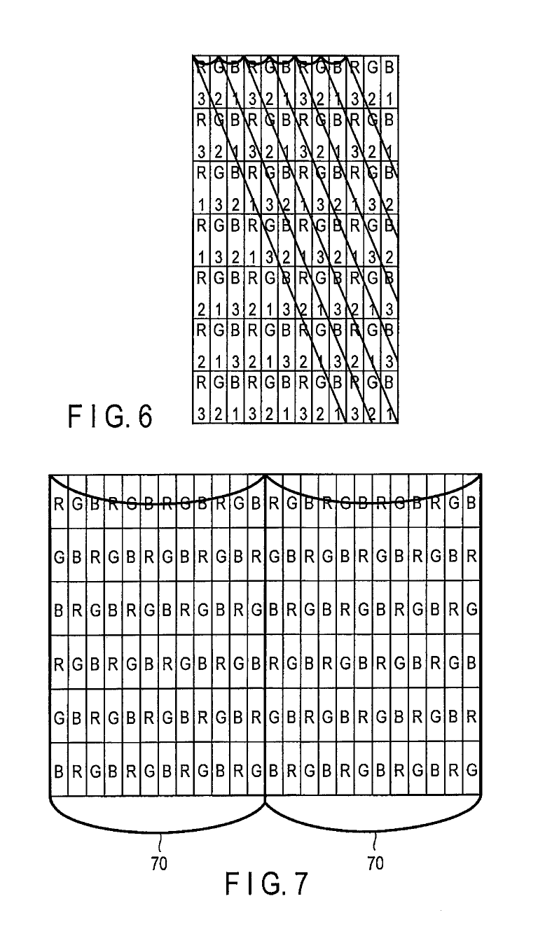

Hence, liquid crystal lenses having a horizontal pitch=1.5 [sub-pixels] of lenses were produced experimentally. In this case, although a visible range was narrow, satisfactory stereoscopic viewing was enabled. FIG. 6 shows the relationship between pixels and liquid crystal lenses when a horizontal pitch of liquid crystal lenses is set to be 1.5 [sub-pixels]. In this example, the number of parallaxes is 3.

(Vertical Lens and Slant Lens)

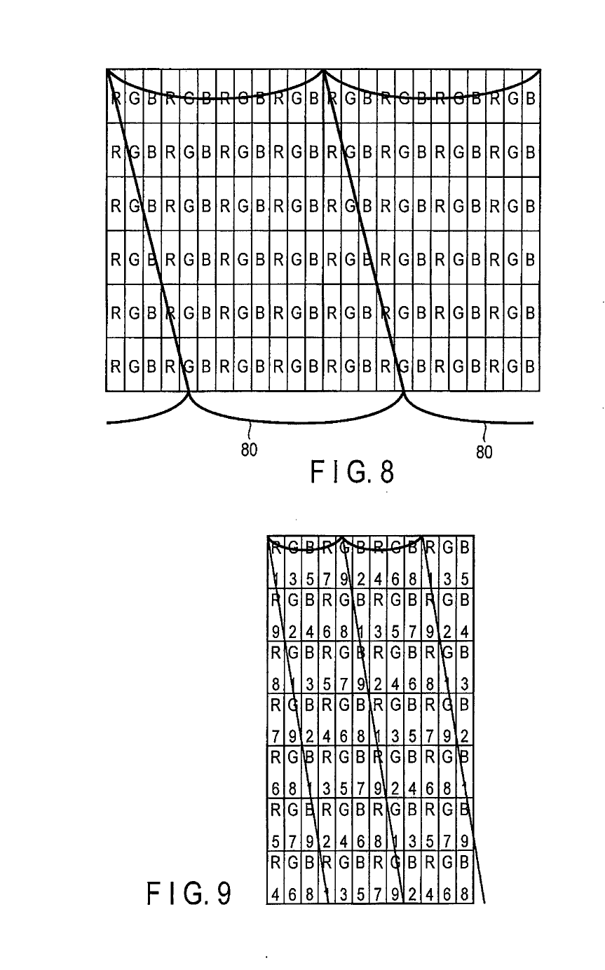

FIG. 7 shows an example in which vertical lenses 70 are laid out on a liquid crystal panel. As a liquid crystal panel which displays a 2D image, one having a mosaic color filter matrix is popularly used. On the other hand, FIG. 8 shows an example in which slant lenses 80 are laid out on a liquid crystal panel. As a liquid crystal panel which displays a 2D image, one having a vertical stripe color filter matrix is popularly used. The vertical stripe color filter matrix is normally used in a 2D monitor or the like, and has a merit that allows use of a general-purpose 2D panel without preparing any special 2D panel. However, a tilt angle and horizontal pitch of lenses are required to be appropriately selected in terms of, for example, moiré suppression.

This embodiment is effective for both vertical and slant layouts of lenses, but it is particularly effective for the slant lens layout. In the case of a 2D/3D switching type, an original 2D panel is directly viewed in a 2D display mode after the lens effect is disabled. For this reason, it is required to use a general-purpose 2D panel. As described above, for the slant lens layout, as a base 2D-display liquid crystal panel, one having the vertical stripe color filter matrix is used. The vertical stripe color filter matrix is normally used in a 2D monitor or the like, and a general-purpose 2D panel can be used without preparing any special 2D panel. The vertical lenses have only one design parameter, that is, a lens pitch, while the slant lenses have two design parameters, that is a lens pitch and tilt angle. Hence, the degrees of freedom in design are high, and various designs can be utilized.

As shown in FIG. 9 (corresponding to the same example as FIG. 5B), when the tilt angle θ of the slant lenses is a tan(1/n) and n=6, and the horizontal pitch p of the lenses is 3×the number of parallaxes/n (unit: a sub-pixel width), a periodic density pattern, that is, moiré, is generated on a display image. For n=1/tan θ. Or n=m/p.

For example, in the case of nine parallaxes, when n=6, and the horizontal pitch is about 3×9/6=4.5 [sub-pixel widths], moiré is generated. Therefore, such horizontal pitch region cannot obtain a satisfactory 3D image in terms of moiré although the effect of this embodiment is expected. In consideration of production errors, it is desirable to make a design by excluding a range of the horizontal pitch p from 0.999 times to 1.001 times of 3× the number of parallaxes/n.

Also, when the tilt angle θ of each slant lens is a tan(1/n) and n=3, and the horizontal pitch p of the lenses is 3×the number of parallaxes/n (unit: a sub-pixel width), a periodic density pattern, that is, moiré, is generated on a display image. In this case as well, in consideration of production errors, it is desirable to make a design by excluding a range of the horizontal pitch p from 0.999 times to 1.001 times of 3×the number of parallaxes/n.

(Another Embodiment)

In the case of a 40″-class 2D/3D switching type large-screen 3D display, a panel having about 4000 horizontal pixels can be used as a base 2D panel. In order to enhance a stereoscopic effect, the number of parallaxes is preferably large, but a 3D resolution lowers in such case. For this reason, a well-balanced design is required. For example, in order to obtain a 3D resolution equivalent to a high-definition television, it is appropriate to use about nine parallaxes. At this time, if the horizontal lens pitch of liquid crystal lenses, which are obliquely laid out, is 9 [sub-pixels], the thickness of the liquid crystal layer in each liquid crystal lens is as large as about 200 [microns], and a stable lens effect cannot be obtained.

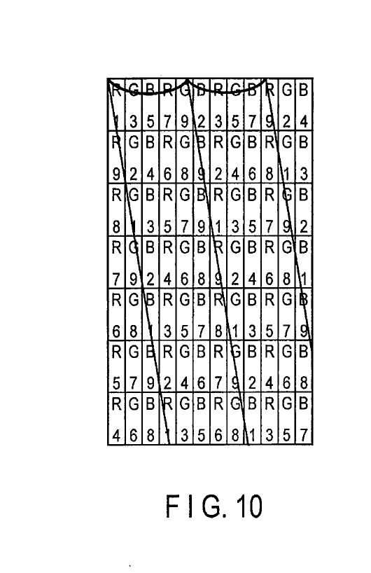

Hence, this embodiment is applied to nearly halve the horizontal lens pitch of the lenses, as shown in FIG. 10. More specifically, when the tilt angle θ of the lenses is a tan(1/n), the horizontal pitch p of the lenses can be set to be about 3×the number of parallaxes/n (unit: a sub-pixel width). However, the number N of parallaxes=9, and n=1/tan θ, that is, a value slightly smaller than 6. As a result, the thickness of the liquid crystal layer in each lens can be reduced to about 100 [μm]. Parallax information can be assigned to pixels, as shown in FIG. 10. With this arrangement, a satisfactory 3D image can be viewed while the lenses are ON, and a high-definition 2D image can be viewed while the lenses are OFF.

According to the aforementioned embodiment, when a large-size panel is adopted, the lens pitch is set to be nearly half the conventional pitch to nearly halve the thickness of the liquid crystal layer, thus realizing stable liquid crystal lenses. Therefore, a 3D image display apparatus which can suppress a 3D image quality drop when a large-size panel is adopted can be provided. When the aforementioned 2D/3D switching arrangement is adopted, a 3D image can be displayed to have a rich stereoscopic effect, and a 2D image can be displayed to have a high resolution. Furthermore, according to this embodiment, since the thickness of the liquid crystal layer can be nearly halved, a use amount of a liquid crystal material can be greatly reduced, thus also attaining a cost reduction at the time of manufacture.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional image display apparatus comprising:
a display unit in which a plurality of sub-pixels are arrayed in a matrix in a first direction and a second direction; and
liquid crystal lenses arrayed in the first direction at not more than a horizontal pitch p, a unit of the horizontal pitch p being a width of the sub-pixel, which is expressed by:
$$p = 3 \times \sqrt{\frac{N \times 3 - 1}{3}}$$
where N is the number of parallaxes.

2. The apparatus of claim 1, wherein the horizontal pitch p of the liquid crystal lenses is larger than one sub-pixel width.

3. The apparatus of claim 2, wherein a ridge direction of each liquid crystal lens is tilted with respect to the second direction.

4. The apparatus of claim 3, wherein letting θ be a tilt angle of the ridge direction of the liquid crystal lens with respect to the second direction, and n=1/tan θ (n=3 or 6),
the horizontal pitch p of the liquid crystal lenses is set by excluding a range from 0.999 times to 1.001 times of 3×the number of parallaxes/n.

5. The apparatus of claim 3, wherein letting θ be a tilt angle of the ridge direction of the liquid crystal lens with respect to the second direction,
θ=a tan(1/n), and
n=1/tan θ,
the horizontal pitch p of the liquid crystal lenses is set to be 3×the number of parallaxes/n (unit: a sub-pixel width).
